(19) United States
(12) Patent Application Publication
(10) Pub. No.: US 2006/0052486 A1
(43) Pub. Date: Mar. 9, 2006

(54) Resin composition, ultraviolet radiation shielding transparent resin form, and ultraviolet radiation shielding transparent resin laminate

(75) Inventor: Kenichi Fujita, Chiba (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: SUMITOMO METAL MINING CO., LTD., Tokyo (JP)

(21) Appl. No.: 11/219,842

(22) Filed: Sep. 7, 2005

(30) Foreign Application Priority Data
Sep. 8, 2004 (JP) 260843/2004

(51) Int. Cl. C08K 9/06

(52) U.S. Cl. 523/212

(57) ABSTRACT

A resin composition in which an inorganic-type ultraviolet absorber stand dispersed in a transparent thermoplastic resin, and the ultraviolet absorber has been surface-treated with a surface treating agent selected from a silane coupling agent, a titanium coupling agent and so forth which have an alkoxyl group or a hydroxyl group and an organofunctional group, where the mixing ratio X of the surface treating agent to the inorganic-type ultraviolet absorber is set within the range of 0.05<X<10, and the proportion of content of the inorganic-type ultraviolet absorber in the transparent thermoplastic resin is set within the range of from more than 0.01% by weight to less than 30% by weight.

### BACKGROUND OF THE INVENTION

1. Field of the Invention

This invention relates to a resin composition in which an inorganic-type ultraviolet absorber having superior weatherability stands dispersed in a transparent thermoplastic resin. More particularly, it relates to a resin composition improved in the dispersibility of inorganic-type ultraviolet absorbers in transparent thermoplastic resins and further kept from photocatalytic activity of the inorganic-type ultraviolet absorbers and from bleeding of metallic ions, and also relates to improvements in an ultraviolet radiation shielding transparent resin form (molded or extruded form) obtained by molding or extruding this resin composition, and an ultraviolet radiation shielding transparent resin laminate.

2. Description of the Related Art

Because of transparency and beautiful external appearance, forms of transparent thermoplastic resins such as acrylic resins, polycarbonate resins and polyester resins are widely utilized as construction materials used in the outdoors, such as skylights, carports, and roofing materials of domes. There, however, has been a problem that ultraviolet radiations included in solar radiations are transmitted through the construction materials constituted of the transparent thermoplastic resins to cause deterioration, change of color, change of properties and so forth of articles placed in the room or in the car. Also, the forms of the transparent thermoplastic resins tend to absorb ultraviolet radiations, and hence the forms themselves may deteriorate as a result of exposure to ultraviolet radiations over a long period of time.

Thus, compared with materials such as glass and metals, the transparent thermoplastic resins have a poor weatherability, and there has been a problem that chemical bonds of C, H and O which form the skeleton of a transparent thermoplastic resin are destroyed as a result of irradiation by ultraviolet radiations for a long time to cause change of color, deterioration of mechanical strength, cracking and so forth.

Accordingly, in order to solve the problems to be caused by ultraviolet radiations, a method has conventionally been attempted in which the transparent thermoplastic resins are compounded with an organic-type ultraviolet absorber. Then, ultraviolet absorbers of a benzophenone type, a benzotriazole type, a triazine type and a salicylate type have been used as the organic-type ultraviolet absorber.

Since, however, such organic-type ultraviolet absorbers are relatively low-molecular substances, they have had a problem that the low-molecular ultraviolet absorbers tend to bleed to the surfaces of forms when the ultraviolet absorbers are kneaded into the transparent thermoplastic resins to produce forms. Also, the organic-type ultraviolet absorbers themselves have a problem on sanitation against human bodies, and also some organic-type ultraviolet absorbers have a structure into which chlorine has been introduced. Hence, taking account of environmental problems such as generation of dioxins, there still has been room for improvement.

Moreover, where the organic-type ultraviolet absorbers are melted and kneaded in high-boiling thermoplastic resins such as polycarbonate resins and polyester resins, there has also been a problem that the ultraviolet absorbers may decompose and deteriorate because of heating, so that their ultraviolet absorptivity may lower or the resins take on color. There is a problem also on the weatherability of the organic-type ultraviolet absorbers themselves, and there is still also a problem that the organic-type ultraviolet absorbers may deteriorate as a result of exposure to ultraviolet radiations for a long time to come to lose their effect gradually.

Accordingly, in order to solve these problems on heat resistance, weatherability and bleeding, it is attempted to use, in place of the above organic-type ultraviolet absorbers, inorganic-type ultraviolet absorbers such as titanium oxide and zinc oxide.

For example, as disclosed in Japanese Patent Application Laid-open No. 2000-63647, proposed are a polyester resin composition prepared by compounding an inorganic-type ultraviolet absorber such as zinc oxide, titanium oxide, cerium oxide or iron oxide and a pigment dispersing agent in a thermoplastic polyester resin, and a form having transparency which is composed of this polyester resin composition.

However, the inorganic-type ultraviolet absorbers, though having superior heat stability and weatherability, have photocatalytic activity on inorganic-type ultraviolet absorber particle surfaces, and hence may accelerate the decomposition and deterioration of thermoplastic resins when melted and kneaded in the thermoplastic resins, to make the resins change in color or have low mechanical properties. There has been such a problem.

In addition, in order to maintain the transparency of thermoplastic resins, the inorganic-type ultraviolet absorbers with which the thermoplastic resins are to be compounded must be made to have particle diameter not larger than the wavelength of visible light rays.

There, however, has been a problem that, when fine particles of inorganic-type ultraviolet absorbers are melted and kneaded in the thermoplastic resins, they may come to have a low dispersibility because of mutual action between the particles to cause agglomeration between the fine particles themselves to tend to produce secondary particles of several micrometers to tens of micrometers.

Accordingly, in order to solve the problems to be caused by the photocatalytic activity and dispersibility and to keep zinc ions from bleeding, proposed as disclosed in Japanese Patent Application Laid-open No. 2003-292818 are an aqueous slurry which contains silica-coated fine zinc oxide particles surface-coated with silica, an organic polymer composition which contains silica-coated fine zinc oxide particles obtained by drying this aqueous slurry and an organic polymer, and a photo-functional form obtained by molding or extruding this organic polymer composition. Also, as disclosed in Japanese Patent Application Laid-open No. 2004-59421, proposed are silica-coated fine zinc oxide particles provided with hydrophobicity by subjecting the surfaces of the above silica-coated fine zinc oxide particles to surface treatment with a hydrophobicity-providing agent such as a silicone oil, an alkoxysilane, a silane coupling agent or a higher fatty acid salt, an organic polymer composition which contains such silica-coated fine zinc oxide particles and a thermoplastic resin, and a form obtained by molding or extruding this organic polymer composition.

The methods disclosed in the above Japanese Patent Applications Laid-open No. 2003-292818 and No. 2004-59421 have lessened the problems to be caused by photocatalytic activity and dispersibility of the inorganic-type ultraviolet absorbers. However, these methods require the preparation of silica-coated fine zinc oxide particles surface-coated with silica, and hence have had a new problem that they are comparatively high in production cost for these compositions and forms, correspondingly to an increase in the number of steps for the treatment.

### SUMMARY OF THE INVENTION

The present invention has been made taking note of such problems. Accordingly, a first object of the present invention is to provide a resin composition improved in the dispersibility of inorganic-type ultraviolet absorbers in transparent thermoplastic resins and also kept from photocatalytic activity of the inorganic-type ultraviolet absorbers and from bleeding of metallic ions, and at the same time achievable of the reduction of production cost.

A second object of the present invention is to also provide an ultraviolet radiation shielding transparent resin form obtained by molding or extruding the above resin composition.

A third object of the present invention is to still also provide an ultraviolet radiation shielding transparent resin laminate having the above ultraviolet radiation shielding transparent resin form.

To achieve these objects, the present inventors have used as an inorganic-type ultraviolet absorber at least one selected from the group consisting of titanium oxide, zinc oxide, cerium oxide and iron oxide, and, without surface-treating the particle surfaces of these inorganic-type ultraviolet absorbers with silica, have surface-treated the particle surfaces of these inorganic-type ultraviolet absorbers with at least one surface treating agent selected from the group consisting of a silane coupling agent, a titanium coupling agent, an aluminum coupling agent and a zirconium coupling agent which have an alkoxyl group or a hydroxyl group and an organofunctional group. As the result, they have found that, contrary to what is disclosed in Japanese Patent Application Laid-open No. 2003-292818, the photocatalytic activity of the inorganic-type ultraviolet absorber and the bleeding of metallic ions can be controlled without coating the particle surfaces of the inorganic-type ultraviolet absorber with silica, and also the dispersibility of the inorganic-type ultraviolet absorber in the transparent thermoplastic resin is improved. The present invention has been accomplished on the basis of such technical discovery.

More specifically, the resin composition according to the present invention is a resin composition which comprises a transparent thermoplastic resin and dispersed therein at least one inorganic-type ultraviolet absorber selected from the group consisting of a titanium oxide, a zinc oxide, a cerium oxide and an iron oxide, and is characterized in that;
the inorganic-type ultraviolet absorber has been surface-treated with at least one surface treating agent selected from the group consisting of a silane coupling agent, a titanium coupling agent, an aluminum coupling agent and a zirconium coupling agent which have an alkoxyl group or a hydroxyl group and an organofunctional group, where the mixing ratio X of the surface treating agent to the inorganic-type ultraviolet absorber (weight of surface treating agent/weight of inorganic-type ultraviolet absorber) is set within the range of 0.05<X<10, and the proportion of content of the inorganic-type ultraviolet absorber in the transparent thermoplastic resin is set within the range of from more than 0.01% by weight to less than 30% by weight.

The ultraviolet radiation shielding transparent resin form according to the present invention is also characterized by being obtained by forming (molding or extruding) the above resin composition in a stated shape.

The ultraviolet radiation shielding transparent resin laminate according to the present invention is still also characterized by being obtained by laminating the above ultraviolet radiation shielding transparent resin form to other transparent substrate.

According to the resin composition of the present invention, it can be improved in the dispersibility of the inorganic-type ultraviolet absorber in the transparent thermoplastic resin and also can be kept from photocatalytic activity of the inorganic-type ultraviolet absorber and from bleeding of metallic ions.

According to the ultraviolet radiation shielding transparent resin form and ultraviolet radiation shielding transparent resin laminate of the present invention, they can be improved in their transparency and weatherability.

### DESCRIPTION OF THE PREFERRED EMBODIMENTS

The present invention is described below in detail.

The resin composition of the present invention is basically constituted of a transparent thermoplastic resin and dispersed therein an inorganic-type ultraviolet absorber.

First, as the inorganic-type ultraviolet absorber, at least one, or a mixture of two or more, selected from the group consisting of a titanium oxide, a zinc oxide, a cerium oxide and an iron oxide may be used. Also, the inorganic-type ultraviolet absorber is more preferable as it has a smaller particle diameter. Taking account of its ultraviolet radiation absorptivity and the transparency of the thermoplastic resin, it may have an average particle diameter of 300 nm or less, and more preferably 30 nm or less. Here, the average particle diameter is the average value of particle diameters of a powder of the inorganic-type ultraviolet absorber which are observed on a transmission electron microscope. As the lower limit, there is no particular limitation. The inorganic-type ultraviolet absorber may preferably have particle diameter as small as possible, as long as such particles can be produced (actually, it is difficult to produce particles having a diameter of less than 1 nm).

Next, the inorganic-type ultraviolet absorber used in the present invention is subjected to surface treatment with at least one surface treating agent selected from the group consisting of a silane coupling agent, a titanium coupling agent, an aluminum coupling agent and a zirconium coupling agent, in order to control the photocatalytic activity at its particle surfaces and the bleeding of metallic ions and to improve its dispersibility in the transparent thermoplastic resin.

As these surface treating agents, used are those having an alkoxyl group or a hydroxyl group, which has an affinity for the particle surfaces of the inorganic-type ultraviolet absorber and is capable of combining with the particle surfaces of the inorganic-type ultraviolet absorber, and an organofunctional group, which has an affinity for the transparent thermoplastic resin. Also, preferred are those which are less causative of decomposition, deterioration, coloring and so forth due to heat at the time of forming.

The alkoxyl group may include a methoxyl group, an ethoxyl group and an isopropoxyl group, and there are no particular limitations thereon as long as it is one capable of undergoing hydrolysis and combining with the particle surfaces of the inorganic-type ultraviolet absorber. Also, the organofunctional group may include alkyl groups, a vinyl group, a γ-(2-aminoethyl) aminopropyl group, a γ-glycidoxypropyl group, a γ-anilinopropyl group, a γ-mercaptopropyl group and a γ-methacryloxypropyl group, and there are no particular limitations thereon as long as it is one having an affinity for the transparent thermoplastic resin.

Incidentally, for the purpose of more improving the dispersibility of the inorganic-type ultraviolet absorber in the transparent thermoplastic resin, an organic polymer dispersing agent (e.g., an acrylic dispersing agent) may also be used in combination with the coupling agent.

In regard to the mixing ratio X of the surface treating agent to the inorganic-type ultraviolet absorber (weight of surface treating agent/weight of inorganic-type ultraviolet absorber), it is required to be set within the range of 0.05<X<10. This is because, if the mixing ratio X of the surface treating agent is 10 or more, the ultraviolet radiation shielding transparent resin form to be obtained from this resin composition may have low mechanical properties and weatherability. This is also because, if on the other hand the mixing ratio X of the surface treating agent is 0.05 or less, the inorganic-type ultraviolet absorber may have an insufficient effect of being surface-treated, so that the dispersibility of the inorganic-type ultraviolet absorber may lower to damage the transparency of the ultraviolet radiation shielding transparent resin form to be obtained or make it unable to sufficiently control the photocatalytic activity of the inorganic-type ultraviolet absorber and the bleeding of metallic ions.

Next, in regard to the proportion of content of the inorganic-type ultraviolet absorber in the transparent thermoplastic resin, it is required to be set within the range of from more than 0.01% by weight to less than 30% by weight, and preferably within the range of from more than 0.05% by weight to less than 10% by weight. This is because, if the proportion of content of the inorganic-type ultraviolet absorber is 30% by weight or more, fine particles of the inorganic-type ultraviolet absorber may mutually agglomerate to make their dispersion in the resin insufficient to damage the transparency of the ultraviolet radiation shielding transparent resin form to be obtained or lower its mechanical properties. This is also because, if on the other hand the proportion of content of the inorganic-type ultraviolet absorber is 0.01% by weight or less, no sufficient ultraviolet radiation absorptivity may be obtainable, depending on the thickness of the ultraviolet radiation shielding transparent resin form to be obtained.

As the transparent thermoplastic resin in the present invention, there are no particular limitations thereon as long as it is a transparent thermoplastic resin having a high light transmittance in the visible light region. For example, it may include transparent thermoplastic resins having, when molded or extruded into a plate of 3 mm in thickness, a visible-light transmittance of 50% or more as prescribed in JIS R 3106 and a haze of 30% or less as prescribed in JIS K 7105. Stated specifically, it may include acrylic resins, polycarbonate resins, vinyl chloride resins, polystyrene resins, polyether sulfone resins, fluorine resins, polyolefin resins and polyester resins. In particular, where it is intended that the ultraviolet radiation shielding transparent resin form or ultraviolet radiation shielding transparent resin laminate obtained from the resin composition of the present invention is used in window materials or the like of various buildings and vehicles, polycarbonate resins, acrylic resins, fluorine resins, polyether imide resins are more preferred taking account of transparency, impact resistance, weatherability and so forth.

As the polycarbonate resins, aromatic polycarbonates are preferred. Such aromatic polycarbonates may include polymers obtained from at least one divalent phenolic compound as typified by 2,2-bis(4-hydroxyphenyl)propane or 2,2-bis(3,5-dibromo-4-hydroxyphenyl)propane and a carbonate precursor as typified by phosgene, diphenyl carbonate or the like, and by a known method such as interfacial polymerization, solution polymerization or solid-phase polymerization.

The acrylic resins may include polymers or copolymers obtained using as a chief raw material methyl methacrylate, ethyl methacrylate, propyl methacrylate or butyl methacrylate and optionally using as a copolymer component an acrylic acid ester having an alkyl group having 1 to 8 carbon atoms, vinyl acetate, styrene, acrylonitrile, methacrylonitrile or the like. Also usable are acrylic resins obtained by more multi-stage polymerization.

The fluorine resins may include polyfluoroethylene, polydifluoroethylene, polytetrafluoroethylene, an ethylene-difluoroethylene copolymer, an ethylene-tetrafluoroethylene copolymer, and tetrafluoroethylene-perfluoroalkoxyethylene copolymers.

As methods for dispersing the inorganic-type ultraviolet absorber in the transparent thermoplastic resin, any methods may be used as long as they are methods by which fine particles of the inorganic-type ultraviolet absorber can uniformly be dispersed in the transparent thermoplastic resin. For example, powder of the inorganic-type ultraviolet absorber, the surface treating agent selected from the group consisting of a silane coupling agent, a titanium coupling agent, an aluminum coupling agent and a zirconium coupling agent which have an alkoxyl group or a hydroxyl group and an organofunctional group and powder or pellets of the transparent thermoplastic resin are uniformly melt-mixed by means of a mixer such as a ribbon blender, a tumbling mixer, Nauta mixer, Henschel mixer, Super mixer or a planetary-screw mixer, and a kneading machine such as Banbury mixer, a kneader, a roll mill, a single-screw extruder or a twin-screw extruder, whereby the resin composition can be prepared in which the fine particles of the inorganic-type ultraviolet absorber stand uniformly dispersed in the transparent thermoplastic resin.

Besides, a method may be used in which a fluid dispersion of the inorganic-type ultraviolet absorber in which dispersion a powder of the inorganic-type ultraviolet absorber and the surface treating agent stand dispersed in any desired solvent is prepared by means of a bead mill, a ball mill or a sand mill or by ultrasonic dispersion, and this fluid dispersion and the powder or pellets of the transparent thermoplastic resin are uniformly melt-mixed while removing the solvent, by means of the above mixer and kneading machine. A method may further be used in which the solvent in the above fluid dispersion of the inorganic-type ultraviolet absorber is removed by a known method and the resultant dried product and the powder or pellets of the transparent thermoplastic resin are uniformly melt-mixed. It may suffice for the inorganic-type ultraviolet absorber to be uniformly dispersed in the transparent thermoplastic resin in the state the former has been surface-treated with the surface treating agent.

Next, as to the ultraviolet radiation shielding transparent resin form of the present invention, it may be obtained by molding or extruding the above resin composition by a known method. The ultraviolet radiation shielding transparent resin form may be made in any desired shape, and may be made in a flat shape and a curved-surface shape. Also, the ultraviolet radiation shielding transparent resin form may have a thickness adjusted to any desired thickness as occasion calls, including the shape of a plate or sheet up to the shape of a film. Further, a resin sheet made in a flat shape may be formed by post-working to have any desired shape such as the shape of a spherical surface. As methods for making this ultraviolet radiation shielding transparent resin form, any methods are available such as injection molding, extrusion, compression molding and rotational molding. In particular, preferred are a method of obtaining the form by injection molding and a method of obtaining the form by extrusion. To obtain a form having the shape of a plate or sheet or the shape of a film, it may be produced by a method in which a transparent thermoplastic resin standing molten which has been extruded using an extruder such as a T-die extruder is taken off while being cooled by means of cooling rolls. It is also possible to produce the ultraviolet radiation shielding transparent resin form by making first the resin composition into pellets by means of a granulator, followed by the same procedure as the above.

The ultraviolet radiation shielding transparent resin laminate is obtained by laminating the ultraviolet radiation shielding transparent resin form to other transparent substrate. For example, an ultraviolet radiation shielding transparent resin form having previously been made in a film shape may be laminated to and integrated with inorganic glass by heat lamination to obtain an ultraviolet radiation shielding transparent resin laminate having the function to shield ultraviolet radiations and the function to prevent scattering of glass if broken. Also, the ultraviolet radiation shielding transparent resin form may be laminated to and integrated with other transparent substrate by co-extrusion, press molding, injection molding or the like simultaneously with the forming for the former to obtain the ultraviolet radiation shielding transparent resin laminate.

The ultraviolet radiation shielding transparent resin laminate described above is usable as a more useful structural material when mutual advantages the form and the substrate have are effectively brought out and at the same time any mutual disadvantages they may have are supplemented.

Examples of the present invention are given below. The technical scope of the present invention is by no means limited to the contents of these Examples.

### EXAMPLE 1

20 g of fine titanium oxide particles (inorganic-type ultraviolet absorber) of 30 nm in average particle diameter, 70 g of toluene, 10 g of a silane coupling agent (SH6040, available from Dow Corning Toray Silicone Co., Ltd.) having a methoxyl group and a γ-glycidoxypropyl group and a proper amount of water were mixed, which were mixed for 30 hours by means of a ball mill using zirconia balls of 0.5 mm in diameter to prepare 100 g of a fluid dispersion of fine titanium oxide particles (Fluid A).

Next, the above Fluid A was so added to acrylic resin as to be in a titanium oxide concentration of 1.0% by weight, and these were uniformly mixed by means of a blender to obtain a resin composition. Thereafter, the resin composition obtained was extruded into a sheet of 2 mm in thickness to obtain an ultraviolet radiation shielding acrylic sheet in which the fine titanium oxide particles stood uniformly dispersed all over.

Optical properties of the acrylic sheet thus produced were measured with a spectrophotometer U-4000, manufactured by Hitachi Ltd., and ultraviolet radiation transmittance (τuv) and visible light transmittance (τv) were calculated according to ISO-9050 and JIS R 3106. Haze was also measured with a haze meter M-150, manufactured by Murakami Color Research Laboratory, and a haze value was calculated according to JIS K 7136.

The optical properties (ultraviolet radiation transmittance, visible light transmittance, and haze) of this sheet, the amount of the inorganic-type ultraviolet absorber added to the transparent thermoplastic resin and that of the surface treating agent, and the mixing ratio X of the surface treating agent to the inorganic-type ultraviolet absorber are shown in Table 1 below.

### EXAMPLE 2

Fine zinc oxide particles (inorganic-type ultraviolet absorber) of 20 nm in average particle diameter and a silane coupling agent (SZ6023, available from Dow Corning Toray Silicone Co., Ltd.) having a methoxyl group and a γ-(2-aminoethyl)aminopropyl group were so added to acrylic resin as to be in concentrations of 0.3% by weight and 0.3% by weight, respectively, and these were uniformly mixed by means of a blender to obtain a resin composition. Thereafter, the resin composition obtained was extruded into a sheet of 2 mm in thickness to obtain an ultraviolet radiation shielding acrylic sheet in which the fine zinc oxide particles stood uniformly dispersed all over.

The optical properties (ultraviolet radiation transmittance, visible light transmittance, and haze) of this sheet, the amount of the inorganic-type ultraviolet absorber added to the transparent thermoplastic resin and that of the surface treating agent, and the mixing ratio X of the surface treating agent to the inorganic-type ultraviolet absorber are shown in Table 1 below.

### EXAMPLE 3

Fine zinc oxide particles (inorganic-type ultraviolet absorber) of 20 nm in average particle diameter and a silane coupling agent (SZ6300, available from Dow Corning Toray Silicone Co., Ltd.) having a methoxyl group and a vinyl group were so added to acrylic resin as to be in concentrations of 6% by weight and 6% by weight, respectively, and these were uniformly mixed by means of a blender to obtain a resin composition. Thereafter, the resin composition obtained was extruded together with an acrylic resin (transparent substrate) of 1.9 mm in thickness by a co-extrusion process to obtain an ultraviolet radiation shielding acrylic-resin laminate constituted of this substrate and laminated to its surface a surface layer of 0.1 mm in thickness in which the fine zinc oxide particles stood uniformly dispersed.

The optical properties (ultraviolet radiation transmittance, visible light transmittance, and haze) of this laminate, the amount of the inorganic-type ultraviolet absorber added to the transparent thermoplastic resin and that of the surface treating agent, and the mixing ratio X of the surface treating agent to the inorganic-type ultraviolet absorber are shown in Table 1 below.

### EXAMPLE 4

20 g of fine zinc oxide particles (inorganic-type ultraviolet absorber) of 20 nm in average particle diameter, 70 g of toluene, 10 g of a silane coupling agent (SH6040, available from Dow Corning Toray Silicone Co., Ltd.) having a methoxyl group and a γ-glycidoxypropyl group and a proper amount of water were mixed, which were mixed for 30 hours by means of a ball mill using zirconia balls of 0.5 mm in diameter to prepare 100 g of a fluid dispersion of fine zinc oxide particles (Fluid B).

Next, the above Fluid B was so added to acrylic resin as to be in a zinc oxide concentration of 0.3% by weight, and the subsequent procedure of Example 1 was repeated to obtain an ultraviolet radiation shielding acrylic sheet in which the fine zinc oxide particles stood uniformly dispersed all over.

The optical properties (ultraviolet radiation transmittance, visible light transmittance, and haze) of this sheet, the amount of the inorganic-type ultraviolet absorber added to the transparent thermoplastic resin and that of the surface treating agent, and the mixing ratio X of the surface treating agent to the inorganic-type ultraviolet absorber are shown in Table 1 below.

### EXAMPLE 5

20 g of fine cerium oxide particles (inorganic-type ultraviolet absorber) of 20 nm in average particle diameter, 70 g of toluene, 10 g of a silane coupling agent (SH6040, available from Dow Corning Toray Silicone Co., Ltd.) having a methoxyl group and a γ-glycidoxypropyl group and a proper amount of water were mixed, which were mixed for 30 hours by means of a ball mill using zirconia balls of 0.5 mm in diameter to prepare 100 g of a fluid dispersion of fine cerium oxide particles (Fluid D).

Next, the above Fluid D was so added to acrylic resin as to be in a cerium oxide concentration of 0.3% by weight, and the subsequent procedure of Example 1 was repeated to obtain an ultraviolet radiation shielding acrylic sheet in which the fine cerium oxide particles stood uniformly dispersed all over.

The optical properties (ultraviolet radiation transmittance, visible light transmittance, and haze) of this sheet, the amount of the inorganic-type ultraviolet absorber added to the transparent thermoplastic resin and that of the surface treating agent, and the mixing ratio X of the surface treating agent to the inorganic-type ultraviolet absorber are shown in Table 1 below.

### EXAMPLE 6

20 g of fine iron oxide particles (inorganic-type ultraviolet absorber) of 23 nm in average particle diameter, 70 g of toluene, 10 g of a silane coupling agent (SH6040, available from Dow Corning Toray Silicone Co., Ltd.) having a methoxyl group and a γ-glycidoxypropyl group and a proper amount of water were mixed, which were mixed for 30 hours by means of a ball mill using zirconia balls of 0.5 mm in diameter to prepare 100 g of a fluid dispersion of fine iron oxide particles (Fluid E).

Next, the above Fluid E was so added to acrylic resin as to be in a iron oxide concentration of 0.1% by weight, and the subsequent procedure of Example 1 was repeated to obtain an ultraviolet radiation shielding acrylic sheet in which the fine iron oxide particles stood uniformly dispersed all over.

The optical properties (ultraviolet radiation transmittance, visible light transmittance, and haze) of this sheet, the amount of the inorganic-type ultraviolet absorber added to the transparent thermoplastic resin and that of the surface treating agent, and the mixing ratio X of the surface treating agent to the inorganic-type ultraviolet absorber are shown in Table 1 below.

### EXAMPLE 7

The procedure of Example 5 was repeated except that PET resin was used in place of the acrylic resin, to obtain an ultraviolet radiation shielding acrylic sheet in which the fine cerium oxide particles stood uniformly dispersed all over.

The optical properties (ultraviolet radiation transmittance, visible light transmittance, and haze) of this sheet, the amount of the inorganic-type ultraviolet absorber added to the transparent thermoplastic resin and that of the surface treating agent, and the mixing ratio X of the surface treating agent to the inorganic-type ultraviolet absorber are shown in Table 1 below.

### EXAMPLE 8

The procedure of Example 5 was repeated except that polycarbonate resin was used in place of the acrylic resin, to obtain an ultraviolet radiation shielding acrylic sheet in which the fine cerium oxide particles stood uniformly dispersed all over.

The optical properties (ultraviolet radiation transmittance, visible light transmittance, and haze) of this sheet, the amount of the inorganic-type ultraviolet absorber added to the transparent thermoplastic resin and that of the surface treating agent, and the mixing ratio X of the surface treating agent to the inorganic-type ultraviolet absorber are shown in Table 1 below.

### EXAMPLE 9

Fine cerium oxide particles (inorganic-type ultraviolet absorber) of 20 nm in average particle diameter and a silane coupling agent (SH6040, available from Dow Corning Toray Silicone Co., Ltd.) having a methoxyl group and a γ-glycidoxypropyl group were so added to ethylene-tetrafluoroethylene copolymer resin (ETFE) as to be in concentrations of 3% by weight and 3% by weight, respectively, and these were uniformly mixed by means of a blender to obtain a resin composition. Thereafter, the resin composition obtained was extruded into a film of 0.2 mm in thickness to obtain an ultraviolet radiation shielding ethylene-tetrafluoroethylene film in which the fine cerium oxide particles stood uniformly dispersed all over.

The optical properties (ultraviolet radiation transmittance, visible light transmittance, and haze) of this film, the amount of the inorganic-type ultraviolet absorber added to the transparent thermoplastic resin and that of the surface treating agent, and the mixing ratio X of the surface treating agent to the inorganic-type ultraviolet absorber are shown in Table 1 below.

### EXAMPLE 10

The procedure of Example 9 was repeated except that polyethylene resin was used in place of the ethylene-tetrafluoroethylene copolymer resin, to obtain an ultraviolet radiation shielding polyethylene film in which the fine cerium oxide particles stood uniformly dispersed all over.

The optical properties (ultraviolet radiation transmittance, visible light transmittance, and haze) of this film, the amount of the inorganic-type ultraviolet absorber added to the transparent thermoplastic resin and that of the surface treating agent, and the mixing ratio X of the surface treating agent to the inorganic-type ultraviolet absorber are shown in Table 1 below.

### EXAMPLE 11

The procedure of Example 9 was repeated except that polyvinyl chloride resin was used in place of the ethylene-tetrafluoroethylene copolymer resin, to obtain an ultraviolet radiation shielding polyvinyl chloride film in which the fine cerium oxide particles stood uniformly dispersed all over.

The optical properties (ultraviolet radiation transmittance, visible light transmittance, and haze) of this film, the amount of the inorganic-type ultraviolet absorber added to the transparent thermoplastic resin and that of the surface treating agent, and the mixing ratio X of the surface treating agent to the inorganic-type ultraviolet absorber are shown in Table 1 below.

### EXAMPLE 12

The procedure of Example 4 was repeated except that a titanium coupling agent (KR44, available from Ajinomoto Co., Inc.) having an isopropoxyl group and a β-(2-aminoethyl)aminoethoxyl group was used in place of the silane coupling agent in Example 4, to obtain an ultraviolet radiation shielding acrylic sheet in which the fine zinc oxide particles stood uniformly dispersed all over.

The optical properties (ultraviolet radiation transmittance, visible light transmittance, and haze) of this sheet, the amount of the inorganic-type ultraviolet absorber added to the transparent thermoplastic resin and that of the surface treating agent, and the mixing ratio X of the surface treating agent to the inorganic-type ultraviolet absorber are shown in Table 1 below.

### EXAMPLE 13

The procedure of Example 4 was repeated except that an aluminum coupling agent (PLENACT AL-M, available from Ajinomoto Co., Inc.) having an isopropoxyl group and an acetoalkoxyl group was used in place of the silane coupling agent in Example 4, to obtain an ultraviolet radiation shielding acrylic sheet in which the fine zinc oxide particles stood uniformly dispersed all over.

The optical properties (ultraviolet radiation transmittance, visible light transmittance, and haze) of this sheet, the amount of the inorganic-type ultraviolet absorber added to the transparent thermoplastic resin and that of the surface treating agent, and the mixing ratio X of the surface treating agent to the inorganic-type ultraviolet absorber are shown in Table 1 below.

### EXAMPLE 14

The procedure of Example 4 was repeated except that a zirconium coupling agent (APG-X, available from Manchem Co.) having a hydroxyl group and an organofunctional group was used in place of the silane coupling agent in Example 4, to obtain an ultraviolet radiation shielding acrylic sheet in which the fine zinc oxide particles stood uniformly dispersed all over.

The optical properties (ultraviolet radiation transmittance, visible light transmittance, and haze) of this sheet, the amount of the inorganic-type ultraviolet absorber added to the transparent thermoplastic resin and that of the surface treating agent, and the mixing ratio X of the surface treating agent to the inorganic-type ultraviolet absorber are shown in Table 1 below.

### COMPARATIVE EXAMPLE 1

The procedure of Example 2 was repeated except that the inorganic-type ultraviolet absorber and the silane coupling agent were not added, to obtain an acrylic sheet.

The optical properties (ultraviolet radiation transmittance, visible light transmittance, and haze) of this sheet are shown in Table 1 below.

### COMPARATIVE EXAMPLE 2

The procedure of Example 2 was repeated except that the silane coupling agent was not added, to obtain an ultraviolet radiation shielding acrylic sheet in which the fine zinc oxide particles stood dispersed.

However, since the surface treating agent was not added, the fine zinc oxide particles came mutually agglomerated, so that it was unable to disperse the fine zinc oxide particles uniformly in the acrylic sheet, and coarse particles were seen in the acrylic sheet obtained.

Hence, no sufficient ultraviolet radiation shielding power was achievable (ultraviolet radiation transmittance: 70%). Also, the coarse particles stood a light scattering source to make the acrylic sheet have a high haze (34.5%) and also have damaged the original transparency.

The optical properties (ultraviolet radiation transmittance, visible light transmittance, and haze) of this sheet and the amount of the inorganic-type ultraviolet absorber added to the transparent thermoplastic resin are shown in Table 1 below.

### COMPARATIVE EXAMPLE 3

The procedure of Example 2 was repeated except that the silane coupling agent (SZ6023, available from Dow Corning Toray Silicone Co., Ltd.) having a methoxyl group and a γ-(2-aminoethyl)aminopropyl group was added in an amount of 0.015% by weight, to obtain an ultraviolet radiation shielding acrylic sheet in which the fine zinc oxide particles (inorganic-type ultraviolet absorber) stood dispersed.

However, since the mixing ratio X of the surface treating agent to the inorganic-type ultraviolet absorber (weight of surface treating agent/weight of inorganic-type ultraviolet absorber) was 0.05, which was outside the range of “0.05<X<10”, it was unable to surface-treat the fine zinc oxide particle surfaces sufficiently.

Hence, the fine zinc oxide particles came mutually agglomerated, so that it was unable to disperse the fine zinc oxide particles uniformly in the acrylic sheet, and coarse particles were seen in the acrylic sheet obtained. As the result, no sufficient ultraviolet radiation shielding power was achievable (ultraviolet radiation transmittance: 72.4%). Also, the coarse particles stood a light scattering source to make the acrylic sheet have a high haze (29.9%) and also have damaged the original transparency.

The optical properties (ultraviolet radiation transmittance, visible light transmittance, and haze) of this sheet, the amount of the inorganic-type ultraviolet absorber added to the transparent thermoplastic resin and that of the surface treating agent, and the mixing ratio X of the surface treating agent to the inorganic-type ultraviolet absorber are shown in Table 1 below.

### COMPARATIVE EXAMPLE 4

The procedure of Example 2 was repeated except that the silane coupling agent (SZ6023, available from Dow Corning Toray Silicone Co., Ltd.) having a methoxyl group and a γ-(2-aminoethyl)aminopropyl group was added in an amount of 3% by weight, to obtain an ultraviolet radiation shielding acrylic sheet in which the fine zinc oxide particles (inorganic-type ultraviolet absorber) stood dispersed.

However, since the mixing ratio X of the surface treating agent to the inorganic-type ultraviolet absorber was (weight of surface treating agent/weight of inorganic-type ultraviolet absorber) was 10, which was outside the range of “0.05<X<10”, the acrylic sheet obtained resulted in a low surface strength.

The optical properties (ultraviolet radiation transmittance, visible light transmittance, and haze) of this sheet, the amount of the inorganic-type ultraviolet absorber added to the transparent thermoplastic resin and that of the surface treating agent, and the mixing ratio X of the surface treating agent to the inorganic-type ultraviolet absorber are shown in Table 1 below.

### COMPARATIVE EXAMPLE 5

The procedure of Example 2 was repeated except that the fine zinc oxide particles were added in an amount of 30% by weight and the silane coupling agent (SZ6023, available from Dow Corning Toray Silicone Co., Ltd.) having a methoxyl group and a γ-(2-aminoethyl)aminopropyl group was added in an amount of 10% by weight, to obtain an ultraviolet radiation shielding acrylic sheet in which the fine zinc oxide particles (inorganic-type ultraviolet absorber) stood dispersed.

However, since the proportion of content of the fine zinc oxide particles (inorganic-type ultraviolet absorber) in the acrylic sheet was as large as 30% by weight, which was beyond the range of “from more than 0.01% by weight to less than 30% by weight”, the fine zinc oxide particles came mutually agglomerated, and coarse particles were seen in the acrylic sheet obtained. Also, the coarse particles stood a light scattering source to make the acrylic sheet have a high haze (in contrast to the haze value which was 1.7 to 2.6 in Examples 1 to 6, in which the acrylic resin was used as the transparent thermoplastic resin, it was 7.3 in this Comparative Example, in which the acrylic resin was likewise used) and also have damaged the original transparency.

The optical properties (ultraviolet radiation transmittance, visible light transmittance, and haze) of this sheet, the amount of the inorganic-type ultraviolet absorber added to the transparent thermoplastic resin and that of the surface treating agent, and the mixing ratio X of the surface treating agent to the inorganic-type ultraviolet absorber are shown in Table 1 below.

### COMPARATIVE EXAMPLE 6

The procedure of Example 2 was repeated except that the fine zinc oxide particles were added in an amount of 0.01% by weight and the silane coupling agent (SZ6023, available from Dow Corning Toray Silicone Co., Ltd.) having a methoxyl group and a γ-(2-aminoethyl)aminopropyl group was added in an amount of 0.03% by weight, to obtain an ultraviolet radiation shielding acrylic sheet in which the fine zinc oxide particles (inorganic-type ultraviolet absorber) stood dispersed.

However, since the proportion of content of the fine zinc oxide particles (inorganic-type ultraviolet absorber) in the acrylic sheet was as small as 0.01% by weight, which was outside the range of “from more than 0.01% by weight to less than 30% by weight”, no sufficient ultraviolet radiation shielding power was achievable (ultraviolet radiation transmittance: 81.4%).

The optical properties (ultraviolet radiation transmittance, visible light transmittance, and haze) of this sheet, the amount of the inorganic-type ultraviolet absorber added to the transparent thermoplastic resin and that of the surface treating agent, and the mixing ratio X of the surface treating agent to the inorganic-type ultraviolet absorber are shown in Table 1 below.

### COMPARATIVE EXAMPLE 7

The procedure of Example 2 was repeated except that an organic polymer dispersing agent (an acrylic dispersing agent) was used in place of the silane coupling agent in Example 2, to obtain an ultraviolet radiation shielding acrylic sheet in which the fine zinc oxide particles stood uniformly dispersed all over.

However, the organic polymer dispersing agent had decomposed because of the heat at the time of extrusion, and the sheet obtained had colored in brown to have damaged the original transparency inherent in the acrylic resin.

The optical properties (ultraviolet radiation transmittance, visible light transmittance, and haze) of this sheet and the amount of the inorganic-type ultraviolet absorber added to the transparent thermoplastic resin and that of the organic polymer dispersing agent are shown in Table 1 below.

### COMPARATIVE EXAMPLE 8

The procedure of Comparative Example 1 was repeated except that, in Comparative Example 1, PET (polyethylene terephthalate) resin was used in place of the acrylic resin, to obtain a PET sheet.

The optical properties (ultraviolet radiation transmittance, visible light transmittance, and haze) of this sheet are shown in Table 1 below.

### COMPARATIVE EXAMPLE 9

The procedure of Comparative Example 1 was repeated except that, in Comparative Example 1, polycarbonate resin was used in place of the acrylic resin, to obtain a polycarbonate sheet.

The optical properties (ultraviolet radiation transmittance, visible light transmittance, and haze) of this sheet are shown in Table 1 below.

### COMPARATIVE EXAMPLE 10

The procedure of Example 9 was repeated except that, in Example 9, the inorganic-type ultraviolet absorber and the silane coupling agent were not added, to obtain an ethylene-tetrafluoroethylene film.

The optical properties (ultraviolet radiation transmittance, visible light transmittance, and haze) of this film are shown in Table 1 below.

### COMPARATIVE EXAMPLE 11

The procedure of Comparative Example 10 was repeated except that, in Comparative Example 10, polyethylene resin was used in place of the ethylene-tetrafluoroethylene copolymer resin, to obtain a polyethylene film.

The optical properties (ultraviolet radiation transmittance, visible light transmittance, and haze) of this film are shown in Table 1 below.

### COMPARATIVE EXAMPLE 12

The procedure of Comparative Example 10 was repeated except that, in Comparative Example 10, polyvinyl chloride resin was used in place of the ethylene-tetrafluoroethylene copolymer resin, to obtain a polyvinyl chloride film.

The optical properties (ultraviolet radiation transmittance, visible light transmittance, and haze) of this film are shown in Table 1 below.

TABLE 1

| | | Inorganic-type | | Surface | | | | | Optical | | |
|---|---|---|---|---|---|---|---|---|---|---|---|
| | Transparent | ultraviolet absorber | | treating agent | | | | | characteristics | | |
| | thermoplastic | | Amt. | | Amt. | | | Thickness | τuv | τv | Haze |
| | resin | Type | (wt %) | Type | (wt %) | X*1 | Layer | (mm) | (%) | (%) | (%) |
| Example: | | | | | | | | | | | |
| 1 | Acrylic | Titanium oxide | 1 | SilCA | 0.5 | 0.5 | Single | 2 | 9.2 | 87 | 1.8 |
| 2 | Acrylic | Zinc oxide | 0.3 | SilCA | 0.3 | 1 | Single | 2 | 2.2 | 87.5 | 2.5 |
| 3*2 | Acrylic | Zinc oxide | 6 | SilCA | 6 | 1 | Double | 0.1 + 1.9 | 2.1 | 87.2 | 2.6 |
| 4 | Acrylic | Zinc oxide | 0.3 | SilCA | 0.15 | 0.5 | Single | 2 | 2.2 | 88.1 | 1.9 |
| 5 | Acrylic | Cerium oxide | 0.3 | SilCA | 0.15 | 0.5 | Single | 2 | 5.8 | 83.5 | 1.8 |
| 6 | Acrylic | Iron oxide | 0.1 | SilCA | 0.05 | 0.5 | Single | 2 | 0.1 | 75.1 | 1.7 |
| 7 | PET | Cerium oxide | 0.3 | SilCA | 0.15 | 0.5 | Single | 2 | 3.1 | 82.1 | 2.1 |
| 8 | PC | Cerium oxide | 0.3 | SilCA | 0.15 | 0.5 | Single | 2 | 1.3 | 83.5 | 1.8 |
| 9 | ETFE | Cerium oxide | 3 | SilCA | 3 | 1 | Single | 0.2 | 5.7 | 82.3 | 6.8 |
| 10 | PE | Cerium oxide | 3 | SilCA | 3 | 1 | Single | 0.2 | 5.5 | 82.9 | 8.8 |
| 11 | PVC | Cerium oxide | 3 | SilCA | 3 | 1 | Single | 0.2 | 5.4 | 83 | 1.7 |
| 12 | Acrylic | Zinc oxide | 0.3 | TiCA | 0.15 | 0.5 | Single | 2 | 2.3 | 87.9 | 1.9 |
| 13 | Acrylic | Zinc oxide | 0.3 | AlCA | 0.15 | 0.5 | Single | 2 | 2.3 | 87.2 | 1.5 |
| 14 | Acrylic | Zinc oxide | 0.3 | ZrCA | 0.15 | 0.5 | Single | 2 | 2.4 | 86.9 | 1.9 |
| Comparative | | | | | | | | | | | |
| Example: | | | | | | | | | | | |
| 1 | Acrylic | — | — | — | — | — | Single | 2 | 89.4 | 92.4 | 0.5 |
| 2 | Acrylic | Zinc oxide | 0.3 | — | — | 0 | Single | 2 | 70.7 | 82.4 | 34.5 |
| 3 | Acrylic | Zinc oxide | 0.3 | SilCA | 0.015 | 0.05 | Single | 2 | 72.4 | 83.4 | 29.9 |
| 4 | Acrylic | Zinc oxide | 0.3 | SilCA | 3 | 10 | Single | 2 | 2.2 | 86.6 | 2.2 |
| 5 | Acrylic | Zinc oxide | 30 | SilCA | 10 | 0.33 | Single | 2 | 0.1 | 77.5 | 7.3 |
| 6 | Acrylic | Zinc oxide | 0.01 | SilCA | 0.03 | 3 | Single | 2 | 81.4 | 91.6 | 0.8 |
| 7 | Acrylic | Zinc oxide | 0.3 | OPDA | 0.3 | 1 | Single | 2 | 2.1 | 75 | 1.3 |
| 8 | PET | — | — | — | — | — | Single | 2 | 49.7 | 90.4 | 1.1 |
| 9 | PC | — | — | — | — | — | Single | 2 | 19.1 | 91.8 | 1 |
| 10 | ETFE | — | — | — | — | — | Single | 0.2 | 88.5 | 91.2 | 5.1 |
| 11 | PE | — | — | — | — | — | Single | 0.2 | 88.2 | 90.8 | 6.5 |
| 12 | PVC | — | — | — | — | — | Single | 0.2 | 87.4 | 91.6 | 1.2 |

SilCA: Silane coupling agent;
TiCA: Titanium coupling agent;
AlCA: Aluminum coupling agent
ZrCA: Zirconium coupling agent;
OPDA: Organic polymer dispersing agent
*1X = weight of surface treating agent/weight of inorganic UV absorber
*2Zinc oxide and silane coupling agent were added to surface layer of 0.1 mm thick.

Confirmation

In Examples 1 to 14, the inorganic-type ultraviolet absorber comprising the titanium oxide, the zinc oxide, the cerium oxide or the iron oxide is surface treated with the surface treating agent comprising the silane coupling agent, the titanium coupling agent, the aluminum coupling agent or the zirconium coupling agent, whereby the resin composition can be obtained in which the inorganic-type ultraviolet absorber stands uniformly dispersed in the transparent thermoplastic resin.

The resin composition is further formed (molded or extruded) in any desired shape, whereby the ultraviolet radiation shielding transparent resin form can be obtained which less takes on color because of the heat at the time of the forming and has superior ultraviolet radiation shielding power.

Weatherability Test

A weatherability test was conducted on the ultraviolet radiation shielding polycarbonate sheet according to Example 8 (Sample A) and the polycarbonate sheet according to Comparative Example 9 (Sample B).

A xenon weatherometer “Ci 4000”, manufactured by Atlas Co., was used as an instrument for the weatherability test, and a 1,000 hour test was conducted according to IS04892-2.

As the result, in Sample A, no change was seen in transparency and color tones. In Sample B, however, the sheet surface came finely cracked to have a haze of as high as 50% and have damaged the transparency.

Thus, it has been confirmed that the weatherability of the resin itself is also improved where the inorganic-type ultraviolet absorber surface-treated with the surface treating agent is made to be uniformly dispersed in the transparent thermoplastic resin.

What is claimed is:

1. A resin composition which comprises a transparent thermoplastic resin and dispersed therein at least one inorganic-type ultraviolet absorber selected from the group consisting of a titanium oxide, a zinc oxide, a cerium oxide and an iron oxide, wherein;
said inorganic-type ultraviolet absorber has been surface-treated with at least one surface treating agent selected from the group consisting of a silane coupling agent, a titanium coupling agent, an aluminum coupling agent and a zirconium coupling agent which have an alkoxyl group or a hydroxyl group and an organofunctional group, where the mixing ratio X of the surface treating agent to said inorganic-type ultraviolet absorber (weight of surface treating agent/weight of inorganic-type ultraviolet absorber) is set within the range of 0.05<X<10, and the proportion of content of said inorganic-type ultraviolet absorber in said transparent thermoplastic resin is set within the range of from more than 0.01% by weight to less than 30% by weight.

2. The resin composition according to claim 1, wherein said inorganic-type ultraviolet absorber is in the form of fine particles having an average particle diameter of 300 nm or less.

3. The resin composition according to claim 1, wherein said transparent thermoplastic resin is at least one selected from the group consisting of an acrylic resin, a polycarbonate resin, a vinyl chloride resin, a polystyrene resin, a polyether sulfone resin, a fluorine resin, a polyolefin resins and a polyester resin.

4. An ultraviolet radiation shielding transparent resin form which comprises the resin composition according to claim 1, 2 or 3; said resin composition being molded or extruded in a stated shape.

5. An ultraviolet radiation shielding transparent resin laminate which comprises the ultraviolet radiation shielding transparent resin form according to claim 4; said resin form being laminated to other transparent substrate.
